(19) United States
(12) Patent Application Publication
(10) Pub. No.: US 2006/0048133 A1
(43) Pub. Date: Mar. 2, 2006

(54) Dynamically programmable embedded agents

(76) Inventors: Till Immanuel Patzachke, Wiesbaden (DE); Darren Leroy Wesemann, North Salt Lake, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/216,787

(22) Filed: Aug. 31, 2005

Related U.S. Application Data
(60) Provisional application No. 60/605,736, filed on Aug. 31, 2004.
(60) Provisional application No. 60/606,875, filed on Sep. 1, 2004.

(51) Int. Cl. G06F 9/44

(52) U.S. Cl. 717/168

(57) ABSTRACT

Agents embedded in connectivity devices are dynamically reprogrammed or upgraded without appreciably altering the footprint, requiring the entire agent to be replaced, or exposing the rest of the computing system to possible corruption or failure. The invention is achieved by constructing an agent with a modular programming data structure or architecture and embedding that agent in a connectivity device. New program modules that have been tested in a test agent similar to the embedded agent are added to the embedded agent as new or replacement modules.

### CROSS-REFERENCE TO RELATED APPLICATIONS

This application claims the benefit of U.S. Provisional Patent Application No. 60/605,736, filed Aug. 31, 2004, and of U.S. Provisional Patent Application No. 60/606,875, filed Sep. 1, 2004, both of which are incorporated herein by reference.

### BACKGROUND OF THE INVENTION

1. The Field of the Invention

The present invention relates to embedded software agents which are dynamically programmable in a way that conserves the agent footprint and ensures that new program modules are safe to operate in the embedded agents.

2. The Relevant Technology

More and more services are continually provided to consumers through communications networks. Cable networks, satellite networks, cellular networks, and computer networks such as the Internet are examples of such networks through which various types of services are provided. In fact, the services available through these types of networks are often provided to thousands or millions of consumers. When a user purchases a service from a service provider, the service provider has an interest in insuring that the user receives an accessible and quality product.

One way to provide an accessible and quality product is to perform testing to ensure that connectivity devices, servers or other equipment can serve users as intended without crashing or otherwise failing. Examples of this type of testing can be found, by way of example, in U.S. patent application Ser. No. 10/049,867, incorporated herein by reference, and in U.S. patent application Ser. No. (not yet assigned), filed concurrently with this application, bearing attorney docket number 16079.6.1, and also incorporated herein by reference. These foregoing patent applications disclose systems and methods for testing of networks and network components.

Testing on network devices can be performed through the use of software agents. Agents are often embedded in electronics or other devices. For instance, agents can be used to test, monitor, or control a variety of devices or systems, such as electronics devices, industrial equipment, network components, consumer products, etc. Because agents are embedded in devices, three of the factors that influence the design and operation of agents are that they generally should (1) have a small footprint, (2) require a small amount of computing resources, particularly when used in devices that are not general-purpose computers, and (3) operate in a stable manner without interfering with other functionality of the devices in which they are embedded. Often, agents have a specifically defined role, and conventional agents are generally not easily upgraded or reprogrammed.

Conventional agents are generally reprogrammed by completely substituting old code with new code or by physically replacing the entire agent. This is problematic not only because it is time and resource intensive, but also because the act of replacing an entire agent can expose the agent as well as the entire computing system in which the agent is embedded to possible corruption and failure. Thus, reprogramming or upgrading agents has generally posed a significant risk of compromising the integrity of the entire system in which the agents are embedded. It would therefore represent an advance in the art to provide improved methods for revising or upgrading agents on network devices.

### BRIEF SUMMARY OF THE INVENTION

The present invention relates to systems and methods for dynamically upgrading or replacing embedded agents in connectivity devices. The upgrading or replacing is preferably coordinated by a service provider that provides a communications service to the connectivity device. The embedded agents are dynamically reprogrammed or upgraded without appreciably altering the footprint, requiring the entire agent to be replaced, or exposing the rest of the computing system to possible corruption or failure. The invention is achieved by constructing an agent with a modular programming data structure or architecture and embedding that agent in a connectivity device. New program modules that have been tested in a test agent similar to the embedded agent are added to the embedded agent as new or replacement modules.

Accordingly, a first example embodiment of the invention is a method, in a device that has an embedded agent of obtaining an upgrade for an embedded agent. The method generally includes: providing an embedded agent having one or more existing program modules configured to obtain test data, wherein the embedded agent includes one or more agent modules in addition to the existing program modules; and receiving a new program module and storing the new program module such that the new program module is made available to the embedded agent, wherein: the new program module is encoded in machine code; and the new program module has been tested using a test agent prior to being received at the device.

A second example embodiment of the invention is a method for dynamically monitoring the status of a connectivity device having embedded agent software. This method generally includes: operating the embedded agent with one or more existing program modules, wherein the embedded agent includes one or more agent modules that communicate with the existing program modules; from a network device, transmitting system test data to the embedded agent; receiving returned test data from the embedded agent; and determining based on the returned test data whether to alter one or more existing program modules in the embedded agent by: transmitting to the embedded agent a new program module; and storing the new program module such that the new program module is made available to the embedded agent.

Yet another example embodiment of the invention is a dynamic embedded agent that generally includes: an input/output module; a control module; at least one program module that includes code for implementing an operation of the embedded agent, the at least one program module having been compiled and tested in a test agent prior to being made available to the embedded agent; and an application program that enables the input/output module and the control module to communicate with the at least one program module.

Still yet another example embodiment of the invention is a dynamic embedded agent that generally includes: at least one program module that includes code for implementing an operation of the embedded agent to obtain test data, the at least one program module having been compiled and tested in a test agent prior to being made available to the embedded agent; agent code configured to interface with the program module to enable the program module to create test data in response to the operation of the embedded agent and to initiate the transmission of the test data in data packets; and a microkernel configured to preformat the data packets prior to transmitting the data packets to an operating system associated with the agent.

These and other objects and features of the present invention will become more fully apparent from the following description and appended claims, or may be learned by the practice of the invention as set forth hereinafter.

### BRIEF DESCRIPTION OF THE DRAWINGS

To further clarify the advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an example environment in which embodiments of the invention can be practiced;

FIG. 2 illustrates a device having embedded agent software according to an example embodiment of the invention;

FIG. 3 illustrates another device having embedded agent software according to a further example embodiment of the invention; and

FIG. 4 illustrates testing at least portions of agent software before transmitting that portion of the agent software to a device that has an embedded agent according to another example embodiment of the invention.

### DETAILED DESCRIPTION OF THE PREFERRED EMBODIMENTS

In the following description, numerous specific details are set forth in order to provide a thorough understanding of the present invention. It will be obvious, however, to one skilled in the art that the present invention may be practiced without these specific details. In other instances, well-known aspects of networks, service providers, protocols, and the like have not been described in particular detail in order to avoid unnecessarily obscuring the present invention. Where reference is made to the figures, like structures may be provided with like reference designations. It is understood that the drawings are diagrammatic and schematic representations of presently preferred embodiments of the invention, and are not limiting of the present invention nor are they necessarily drawn to scale.

The present invention permits embedded agents to be programmed with dynamic functionality. In addition, the present invention allows embedded agents to be dynamically reprogrammed or upgraded without appreciably altering the footprint, requiring the entire agent to be replaced, or exposing the rest of the computing system to possible corruption or failure. The invention is achieved by constructing an agent with a modular programming data structure or architecture.

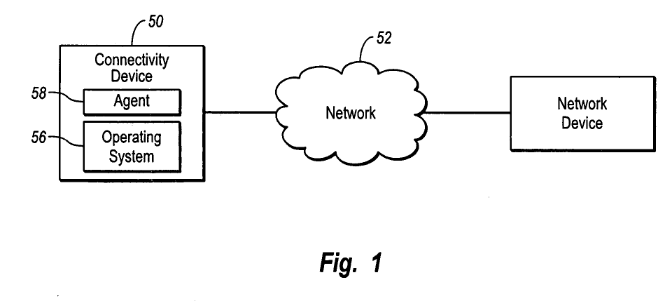

Accordingly, FIG. 1 illustrates various exemplary environments in which the invention can be practiced. In FIG. 1, a connectivity device 50 is illustrated. The connectivity device can be, by way of example only: a desktop or laptop computer a set-top box, a cable modem, a telephone, a cellular telephone, a personal digital assistant, other connectivity devices, and the like or any combination thereof. The connectivity device includes, among other things, an operating system 56 and an agent 58. The agent in each device can be configured to measure and/or monitor a user experience by, for example: load testing, testing network connectivity and access to an ISP; testing the quality of services delivered to end users; monitoring service level agreements for bandwidth-on-demand; and monitoring network access to content servers, application servers, etc.

The depicted connectivity device 50 is in communication with a network device 54 via a network 52. The network device 54 can be a device used by a service provider to provide a service to connectivity device 50 or can be a device used more specifically for directing and evaluating testing in a controlled environment. The network 52 represents various types of connections that connect connectivity device 50 to network device 54, examples of which include, but are not limited to: a direct connection, cellular, dial-up, DSL, ISDN, broadband networks, fiber optic networks, and the like or any combination thereof.

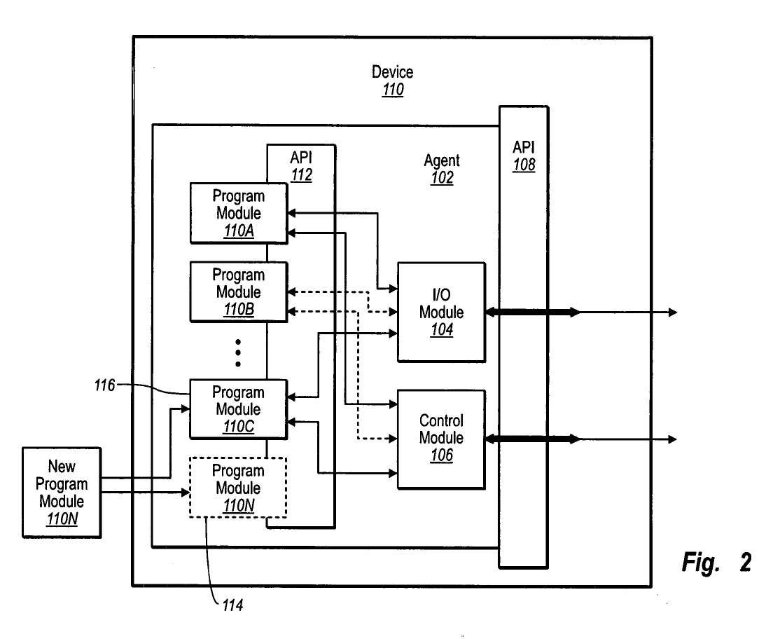

FIG. 2 illustrates in greater detail an exemplary connectivity device 110 having a deployed software agent 102, embedded therein. In general, agents embedded in devices, such as the agent 102 illustrated in FIG. 2, operate in a restricted environment in terms of the computational and data storage resources that are available to the agent. In addition, as has been noted herein, conventional techniques of upgrading the functionality of otherwise modifying the software executed by embedded agents are difficult and often has required the entire agent to be replaced. In many cases, the difficulty of modifying the software has essentially prevented deployed agents from being upgraded or modified.

The deployed agent 102 illustrated in FIG. 2 has agent modules including an Input/Output (I/O) module 104, a control module 106, and uses an application programming interface (API) 108. In various embodiments of the invention, the (I/O) module 104 and the control module 106 may be combined in a single module. Although not shown, it will be understood by those skilled in the art that the API 108 interacts with an operating system or at least some sort of basic input/output system located on the device 110.

The novel architecture of deployed agent 102 contemplates that deployed agent 102 can include any number of program modules 110A, 110B through 110C. Program modules 110A through 110C represent program modules which originally reside in a data structure associated with the deployed agent 102 or which may have been replaced or upgraded at any point in the future. The program modules may comprise modules for testing the services provided to an end-user. Testing the services provided to an end user can include, but is not limited to: proactive measurement of a user's experience across a network by accurately replicating real user activities, monitoring the services provided to the end user, measuring various metrics or, parameters related to the connectivity device of the end user, and the like. Advantageously, embodiments of the present invention occur from the perspective of the end user using an agent that is embedded in the device of the end user. The agent thus provides visibility into the accuracy of the user's experience and can accurately measure the services provided the end user. Program modules 110 can thus be selected and upgraded to provide the desired visibility into user experiences.

To accurately measure the service provided to an end user, the tests may be related to a service level agreement of the user. Agents are not limited, however, to performing tests or taking measurements that are related to an end user's service level agreement, but can also perform other tests or measurements. One benefit of configuring an agent to perform actions that correspond with a particular service level agreement is that the agent can provide data that can be used to evaluate the quality of the services delivered to the end user. Accordingly, each connectivity device may have different program modules 110 that are revised based on the nature of the service level agreement of the user. When the agents embedded in the connectivity devices are adapted to the service level agreement of the end user, the agent can simulate user activity to measure the quality or performance of the service(s) being provided to the end user, including voice over IP, bandwidth-on-demand, video-on-demand, video conferencing, and the like. The agent can also measure or gauge the network connectivity and/or access to an ISP. The data collected by the, agent reflects the experience of a real end user because the tests or measurements are being performed from the connectivity device of the end user.

Examples of protocols that can be tested for the different types of services and networks include access protocols such as: ATM (Asynchronous Transfer Mode), PPoEoA (Point-to-Point Protocol over Ethernet over. ATM), PPPoA (Point-to-Point Protocol over ATM), PPPoE (Point-to-Point Protocol over Ethernet), PPPoEoA (Point-to-Point Protocol over Ethernet Over ATM), IxRTT, and GPRS; network protocols such as: DHCP (Dynamic Host Configuration Protocol) and IP; application protocols such as HTTP (HyperText Transport Protocol), FTP (File Transfer Protocol), SMTP (Simple Mail Transfer Protocol), POP3 (Post Office Protocol 3), Logon/Logoff, Ping, RTSP (Real Time Streaming Protocol), Telnet, and NNTP (Network News Transfer Protocol).

In addition, the testing agent can be configured to perform tests on the connectivity device itself or on user applications that are run by the connectivity device but not controlled by a service provider. This allows a service provider to understand the quality of performance provided by applications and devices that may be outside its control. For example the performance of an email program, device operating system, or web browser can be tested to determine how well it is performing at various tasks.

The raw test information obtained from individual tests is collected at each agent and used to generate more useful data that predicts a user's quality of experience and help a service provider troubleshoot. By way of example only, examples of test data that can be determined from tests for the HTTP protocol include: start time for the HTTP request, the total time for a response after an HTTP request, header retrieval time, content retrieval time, error breakdown, and other metrics known in the art or readily apparent to those skilled in the art in view of the disclosure herein that are indicative of the quality and length of a task over a network. Similarly, test data can be determined for other protocols under test. For the POP protocol, example tests can include log in time, round trip delay to send a request and get a response, and time to delay a file of a given size.

It will therefore be appreciated that various numbers of program modules 110A through 110C may reside in the data structure of the deployed agent 102, depending on the amount of memory is available to the agent and the particular function of the agent. Ideally, it is desirable that the deployed agent 102 have a small footprint and require as few computational resources as possible. As such, deployed agent 102 may have as few as one program module 110A or as many as required.

Generally, the program modules 110A through 110C provide different functionality and together provide the dynamic functionality of the deployed agent 102. The program modules 110A through 110C interface with the I/O module 104 and control module 106 through a second application programming interface (API) 112. This allows the I/O module 104 and control module 106 to call in and call out different program modules 110A through 110C through API 112 as they are required. Thus, the deployed agent 102 is provided with a dynamic ability to utilize multiple functionalities without depleting resources.

The architecture of the deployed agent 102 having multiple program modules 110A through 110C may also be implemented to provide graded levels of a particular function. For example, program module 110A may represent basic default functionality, program module 110B may represent a module, with slightly more functionality than program module 110A, and program module 110C may represent,a program having even more functionality than either module 110A or 110B, and so on. These grades of the same functionality can be originally included on deployed agent 102. Thus, the module 102 can be programmed with basic, default functionality in program module 110A in the event that other, more complex program modules 110B or 110C, fail. If, for example, high grade module 110C failed to function, device 110 could continue functioning at one of the lower graded modules 110A or 110B until one or more replacement modules are loaded onto deployed agent 102.

Embodiments of the invention also enable the agents to report or collect the data resulting from the various tests or measurements performed by the program modules 110. The transmission of reporting data can preferably be performed using the HTTP protocol that is typically used for the Internet. By formatting the reporting data in the HTTP protocol, the data can be sent through currently existing communication routes in an effective manner. For example, virtual private networks (VPNs) may work with a proxy at the center of an enterprise core that prevents the transmission of many types of data packets. Because HTTP is ubiquitous, packets formatted as web pages in HTTP are more easily recognized by network systems and routed to the intended destination.

The transmission of the data can also be performed using a messaging protocol such as SMTP (email). SMTP is scalable and can handle a large amount of data. In fact, transmitting data from multiple agents deployed on connectivity devices using SMTP takes advantage of the capabilities of existing networks and therefore reduces the likelihood of causing a failure in the network. Embodiments of the invention are not limited to SMTP, however, but can communicate using other protocols as well. The transmission may also depend on the type of device in which the agent is resident. For example, if the agent is a cellular telephone, then SMS, GPRS, or other scalable protocols may be used to transmit the data. In other words, existing networks have demonstrated the ability to handle a large number of transmissions using SMTP without problems. The agents described herein can therefore report results using SMTP. This enables a large number of deployed agents to transmit data that represents the experiences of a large number of end users. The data from the agents can be received by a server (or a server system) and stored in a database. The messages can also be parsed and processed before being stored.

In addition, as shown in FIG. 2, the architecture of the deployed agent 102 allows new program modules 110N to be added to the deployed agent 102 as a new program module (indicated by dashed line 114) or to replace an existing program module (as indicated by dashed line 116). Further, existing program modules 110A through 110C can be deleted from the deployed agent 102 as desired. Once the new program module 110N is uploaded into the data structure associated with the deployed agent 102, it can access or is accessed by the I/O module 104 and control module 106 via the API 112. Thus, any one of program modules 110A through 110C can be upgraded or deleted. This reduces or eliminates the need to replace the entire deployed agent 102. In contrast, conventional techniques of modifying, replacing, adding, or otherwise upgrading agents typically have required the entire deployed agents to be replaced too. Generally, a new program module 110N that has been made available according to the invention is uploaded by creating a connection to the device 110 using any of various means including, but not limited to, internet connection, wireless connection, infrared connection, cable connection, and the like.

The deployed agent 102 preferably has sufficient data storage resources to store the original or existing program modules 110A, 110B or 110C, as well as enough space to include additional new program modules 110N that are upgraded or uploaded to the deployed agent 102.

Further, the novel architecture of the software deployed agent 102 allows a developer to determine whether the code for a new module 110N would cause deployed agent 102 (i.e., an agent operated in a device of an end user) to malfunction. As shown in FIG. 2, a programmer can test module code in a secure environment external of the device 110. Running the new program module 110N externally not only allows the programmer to construct a secure environment, but also reduces the amount of computing resources which would be required to test the new module 110N on the actual deployed agent 102. In another embodiment, actual testing of the new program module 110N can occur on the deployed agent 102 using a virtual machine processor as described in greater detail below.

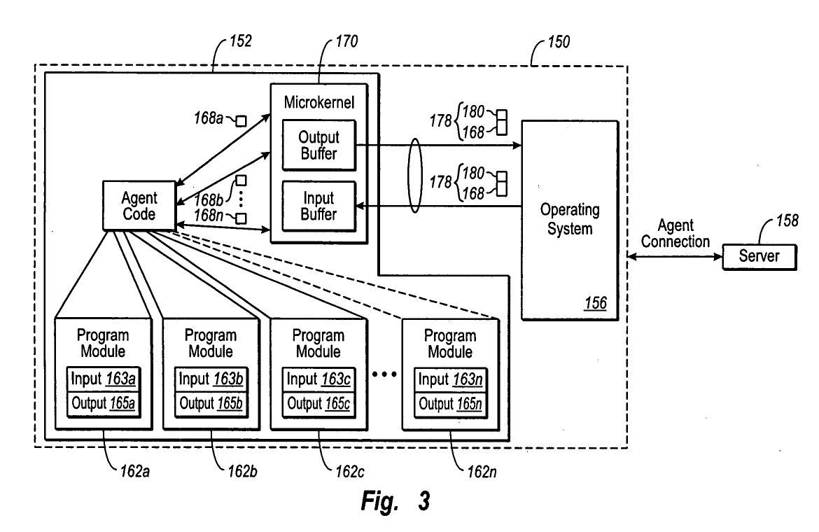

Another example system 150 for dynamically updating an agent is illustrated in FIG. 3. In this embodiment, an agent 152 and an operating system 156 preferably reside on the same connectivity device, as indicated by the dotted line encompassing both. The agent 152 initiates and executes a single process (or small number of processes). Thus, the operating system 156 handles only a single process 104 (or a small number of processes), which minimizes the process switching compared to that which has been required in connection with conventional load testing agents. As will be clear from the following discussion, because the number of processes 104 that the operating system 156 is required to handle is minimal, the processing requirements of the operating system 156 is small, making the present invention extremely efficient and scalable. The agents of the present invention can be defined to operate in a restricted environment in terms of the computational and data storage resources that are available to the agent. For example, agents of the present invention can be embedded on a device, such as a special-purpose monitoring and testing system. Of course, agents of the present invention may also be implemented in operating systems in which the agent has access to other computational and data storage resources, such as a general-purpose computer. Thus, while embodiments of the invention may be shown as having an agent external of an operating system, it will be understood that the agent may actually reside on the operating system and communicate therewith.

With further reference to FIG. 3, the agent 152 includes agent modules agent code 160 and microkernel 170. The single block of agent code 160 includes various program modules 162A-162N. In one example embodiment of the invention, described in greater detail in U.S. patent application Ser. No. (not yet assigned), filed concurrently with this application, bearing attorney docket number 16079.6.1, the program modules represent “microprocesses” and the agent code 160 switches between these multiple instances of microprocesses. Each microprocess in this example embodiment would represent a single simulated user, such that the N microprocesses can simulate an arbitrary number of users. The agent code 160 could then be responsible for switching between the program modules 162A through 162N, which is more efficient than switching among processes by the operating system 156. However, program modules 162 are not necessarily so defined and can represent can test routines or protocols to be tested.

As with program modules 110, program modules 116 can be added, modified, or deleted as necessary. As shown in FIG. 3, the architecture of the agent 152 allows new program module 162N to be added to the deployed agent 152 as a new program module or to replace an existing program module. Further, existing program modules 1162A through 162C can be deleted from the deployed agent 102 as desired. Once the new program module 162N is uploaded into the data structure associated with the deployed agent 152, it can access or is accessed by agent code 160. Thus, any one of program modules 162A through 162N can be upgraded or deleted. This reduces or eliminates the need to replace the entire deployed agent 152. In contrast, conventional techniques of modifying, replacing, adding, or otherwise upgrading agents typically have required the entire deployed agents to be replaced too. Generally, a new program module 162N that has been made available according to the invention is uploaded by creating a connection to the device 50 using any of various means including, but not limited to, internet connection, wireless connection, infrared connection, cable connection, and the like.

As used herein, the terms “microprocess” and “instance” are used interchangeably to represent an aspect of the operation of a test. Each program module 162A through 162N forms instances that can send and receive data over the network. Each program module 162A through 162N contains preformatted input data packets 163 and preformatted output data packets 165. The input data packets 163 and output data packets 165 are essentially data packet templates that contain preformatted protocol and header information to direct agent code 160 how to handle instance data packets 168A through 168N being transmitted or received from the operating system 156. For example, agent code 160 uses the preformatted data in the output data packet 165A to create an instance data packet 168A including data obtained from operation of program module 162A as well as other protocol and/or address information to direct the data packet to an intended destination. Similarly, the agent code 160 could check protocol and header information contained in an incoming instance data packet 168A through 168N and reference information contained in the input data packets 163A through 163N to determine where to return the information carried on the instance data packet.

In other words, instance data packets 168A through 168N can be formatted using some static information and some variable information. That static information, as mentioned above, is the preformatted information containing known information that is applicable to all outgoing and incoming instance data packets 168A through 168N that are generated or received during a load test. This static information can include, but is not limited to, protocol and header information, and is generally identified using the input data packets 163A through 163N and output data packets 165A through 165N. The variable information varies between the program modules 162A through 162N and varies as successive data packets are generated and received by individual program modules 162A through 162N during a load test. The variable information of outgoing data packets is generated using the data 114 for each microprocess, based on the state of the microprocess and the nature of the communication with the network device that is being tested. Because much of the information contained in the data packets is static, the computational requirements of the system are reduced by dynamically generating only the information that varies from data packet to data packet.

As shown in FIG. 3, the agent 152 also includes a microkernel 170 which performs additional functions to reduce the computational requirements of operating system 156. One drawback of conventional testing systems is the fact that the operating system needs to manage the network connections for all N program modules. As will now be discussed, the microkernel 170 significantly reduces this burden on the operating system 156 of forming network connections and managing transmission of the data between the program modules 162A through 162N and the network device 108, for example a server, that is to be subjected to a load test.

In one embodiment, the instance data packets 168A through 168N are further manipulated by the agent 152 to increase the efficiency of the load testing process. When the program module 162 associated with a particular simulated user requires the creation and transmission of an output data packet, the corresponding output data packet is sent to the microkernel 170. As shown in FIG. 3, the microkernel 170 includes an output buffer 174 and an input buffer 176. The output buffer 174 stores instance data packets 168A through 168N and transmits them to the operating system 156.

Before storage in the output buffer 174 or subsequent thereto, the microkernel 170 places preformatted information on each instance data packet to form a formatted data packet 178. While only one formatted data packet 178 is shown, it will be appreciated that microkernel 170 formats each outgoing instance data packet 168 before transmission to the operating system 156. Exemplarily, formatted data packet 178 includes a formatted portion 180 along with the particular instance data packet 168. The formatted portion 180 can include the IP address and IP port of that instance, as well as the IP address and IP port of the formatted data packet destination, as well as Ethernet source and destination addresses, packet types and the like. Thus, the data packets transmitted from the microkernel 170 are herein referred to as formatted data packets 178.

The microkernel 170 then sends the formatted data packet 178 to the operating system 156 which, in turn, sends the formatted data packet to the network network device 108 or any other network device that is involved in the load test. By doing so, the internal packet handling routines of operating system 156 are bypassed, reducing the operating systems functionality to a simple forwarding operation. The microkernel 170 also receives return data packets 182 from the network connection, and can extract data and pass it to the agent code 160. The microkernel 170 may additionally perform checksums or other operations on the incoming data packets 182. Although the operation system 156 receives incoming data packets 182, the incoming data packets are forwarded to the microkernel 170 unprocessed, further reducing the burden on operating system 156.

The function of microkernel 170 is possible without unduly overburdening the computational resources of the microkernel because it is based on the observation that, in a network load test, the nature of the instance data packets 168A through 168N (e.g., the protocols and addresses) that are to be generated and received can be known prior to the test. As discussed above with respect to agent 110 using static information and variable information to create instance data packets 168, in a similar manner, microkernel 170 uses some static information and some variable information to create connection portion 180 of formatted data packet 178. Static information can include information such as, but not limited to, TCP header ports, IP header addresses, and Ethernet headers, while variable information can include things such as, but not limited to, checksums and sequence numbers. The efficiency of the present invention results from reducing the packet creation task to being only concerned with inserting variable information while keeping all of the static information stored in the microkernel 170. Because the static information can be known, preformatting in this manner enhances the efficiency of the process while maintain high accuracy of connection information. As such; microkernel 170 reduces the computational requirements of this process significantly. For this reason, the instance data packets 168A through 168N can be easily generated and handled, as well as formatted data packets 178. Moreover, the function of switching between multiple processes 162A through 162N is relegated to the agent code 160, thus significantly reducing the computational requirements of the operating system 156.

In another embodiment, rather than establishing a network connection, the microkernel may provide access to a network interface, a hard drive or other components of a computer. The agent 152 may be used to send and receive out of band packets. In this embodiment, an agent 152 initiates a single process on a standard operating system. The microkernel 170 formats the instance data packet and sends the instance data packet out of band. The microkernel 170 then monitors all incoming packets for those dedicated to the agent 152.

In still another embodiment, the agent 152 would function substantially as described above, but would have direct access to the hardware of a computer. In this way, the agent 152 could function independent of the main operating system of the computer. These techniques could be used by governmental agencies or other entities that are authorized to monitor communication or computer usage of third parties, and permit such agencies from doing so in a way that is substantially incapable of being detected by the user.

The ability of the microkernel to place formatted connection information 180 onto the outgoing instance data packet 168 to form a formatted data packet 178 further acts to reduce the computation resources required from the operation system 156. In this manner, the operating system 156 does not need to initiate and manage connections for each of the instances, but instead simply receives formatted data packets 178 from the microkernel 170 that can then be transmitted to the network. The complexity of the creation, processing, and formatting of the data packets is essentially hidden from the operating system 156. As mentioned above, because much of the header and connection information can be known in advance, data packets 178 can be preformatted, reducing the processing to simply inserting variable information into the connection information 180 of the formatted data packet 178.

The microkernel 170 makes load testing more efficient and highly scalable. As the agent code 160 switches among the multiple instances or program modules 162A through 162N, microkernel 170 acts as an intermediary and permits the operating system 156 to handle as few as one network connection that is used to send and receive preformatted packets for all microprocess instances 162A through 162N, reducing the operating system's 106 function to handling the network device only. Thus, program modules can be added, modified, or deleted from agent 152 without significantly altering the computational abilities of device 150 or agent 152 or affecting the connectivity between device 150 and network device or server 158.

In one embodiment, a single laptop computer can simulate tens of thousands or more simultaneous users in a load test. Thus, when a network administrator or a developer is to perform a large load test, the availability of hardware is no longer a significant concern. Furthermore, the processing power of the operating system 156 is also not as important as in conventional load testing processes. The present invention thus greatly reduces the cost of performing such large load test.

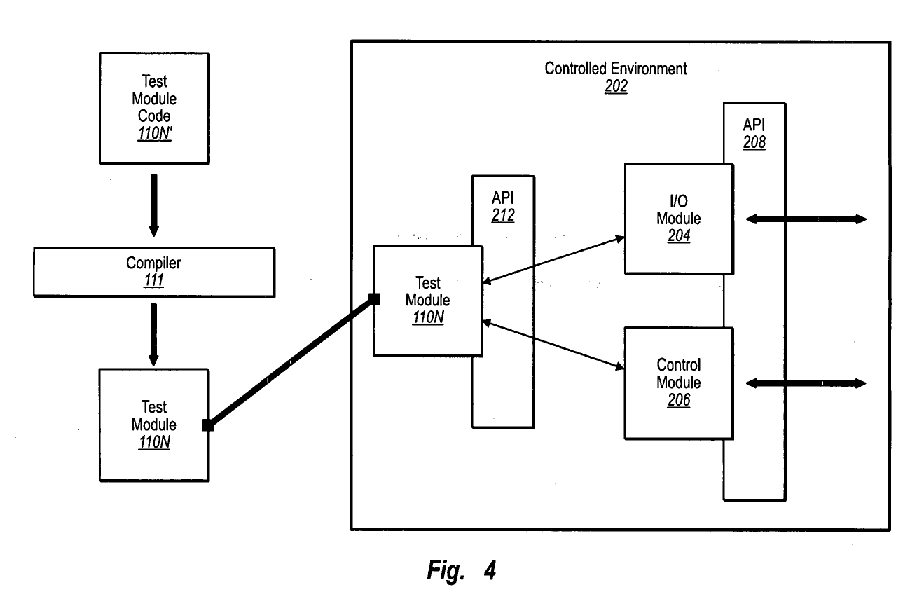

As shown in FIG. 4, in one embodiment, to test the new program module 110N (or, 162N), the developer uses a test agent in a controlled environment 202 which contains substantially similar machine code for both the I/O module 204 and control modules 206 of the deployed agent 102. In addition, although not depicted, a test controlled environment can be structured similar to system 150. Once the new module 110N has been cleared in this manner, it can be confidently transmitted to a deployed agent 102 without the risk of causing the deployed agent 102 to malfunction.

The process of testing a new module 110N generally includes the developer writing source code 110N′ for the new module, which is then compiled using compiler 211 into machine code to create new program module 110N. The new program module 110N is integrated into the test agent 202 and tested for proper interaction with the I/O module 204 and control modules 206 via the API 212. An additional advantage of this method is that any programming language (C, C++, Java, etc.) can be used for the source code 110N′ to create new modules 110N because the new program module 110N is compiled into machine code that is immediately executable by the processor of the particular deployed agent 102 in which the new module 110N will be uploaded. By uploading a new program module 110N that has already been compiled, this eliminates the need to have an additional interpreter on the deployed agent 102, 152 as it is readily executable. Compiled programs run significantly faster than interpreted programs because the program interacts directly with the microprocessor and does not need additional memory space that an interpreter would require. Thus, additional footprint space is reduced or eliminated by not requiring an interpreter to reside on the deployed agent 102, 152.

In an alternative embodiment of the invention, deployed agent 102, or deployed agent 152, includes a virtual machine residing in the deployed agent 102 along with other modules, such as an I/O module 104 and a control module 106. In general, virtual machines require more computing resources than the embodiments of the embedded agents that do not include virtual machines. However, some existing embedded agents have virtual machines, and these embedded agents can be adapted for use with the invention. A virtual machine is a piece of computer software that isolates an application from the rest of the computer. A virtual machine executes application programs and other code using an interpreter, and does so by executing the code itself rather than simply “handling” it to the CPU. In this case, the code can be described as running in a “sand box” environment in which the operating environment of the computing device other than the virtual machine is protected from flaws or malicious parts of the executed program.

According to this embodiment of the invention, the testing process generally include source code 110N′ being compiled into an intermediary machine language such as p-code or bytecode to form a new program module 110N. The new program module 110N can be tested on a test agent having a virtual machine to ensure its proper function. If the new module 110N is problem free, the module 110N is uploaded to the deployed agent 102 in the intermediary machine code (i.e., p-code or bytecode).

As mentioned above, the deployed agent 102, 152 can include a virtual machine capable of running the new program module 110N which is formatted in the intermediary machine language. The footprint of the deployed agent 102, 152 having a Virtual machine may be slightly larger than for an agent without a virtual machine discussed above. However, the footprint is still relatively small since the new program module 110N is still formatted in compiled code, so as to not compromise the potentially very limited operating environment of deployed agent 102, 152. Further, the virtual machine embodiment enables any one of program modules 110A through 110C or 110N to be executed in a protected memory space without affecting any other files of the agent 102, 152. In one embodiment, the virtual machine is a Java virtual machine.

In either case, new program modules 110N can be formatted in strictly compiled machine language or an intermediary machine language, tested, and then uploaded to a deployed agent 102, 152. Further, in either case, testing as described above, allows the developer to determine whether the code will cause the deployed agent to malfunction. The embedded agents that are configured and operate as disclosed herein enable the operating environment to be much more stable and easier to maintain compared to other attempts that might be made to modify deployed agents. Moreover, the agents and the methods of modifying them according to the invention provide a degree of flexibility and utility that has not been possible when using conventional agents. The agents of the invention can be configured to update themselves by periodically accessing new program modules that might be available. In addition, the agents of the invention can be upgraded or modified by technicians, engineers, or maintenance centers, which can be remotely located with respect to the agents. Allowing agents to perform specific tasks on demand opens new ways of customer service since technicians/engineers can interact with individual instances dynamically to resolve specific problems or gain insight into occurring phenomena.

The dynamic nature of the present invention is illustrated in the following example. The present invention can be used to allow a technician to remotely monitor the status of one or more connective devices. As discussed above, connective devices can include, but are not limited to, appliances, set-top television boxes, routers, mobile phones, and the like. Each connective device includes an embedded agent having a modular structure with one or more existing program modules as discussed above. The technician can transmit test data to each embedded agent and, as such, receives returned test data. The technician can evaluate the returned test data to determine if any alterations need to be made in the configuration of the existing program modules or download special diagnostic modules to one or more embedded agent to run problem focused tests and gather further, test/problem specific data. Examples of these types of dynamic processes include debugging of complex network of communication problems, requiring input and actions from users at many (even geographically) different locations, preventive diagnostic tests, and the like. The present invention can also be used for wide-scale upgrades of multiple users at the same time. Pre-testing of the new program modules can be particularly useful for network-wide upgrade to prevent failure of a potentially thousands of user's connective devices.

These are only some examples in which dynamic scalability of the present invention provides distinct advantages over conventional agents. It will be appreciated that this dynamic testing is possible without compromising size or stability of the embedded in each connective device. In addition, dynamic testing as well as upgrading can be done remotely and, if need be, from a single point, thus reducing or even in some cases eliminating the maintenance and services costs associated with diagnostic testing and upgrades.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a device that has an embedded agent, a method of obtaining an upgrade for the embedded agent, comprising:
providing an embedded agent having one or more existing program modules configured to obtain test data, wherein the embedded agent includes one or more agent modules in addition to the existing program modules; and
receiving a new program module and storing the new program module such that the new program module is made available to the embedded agent, wherein:
the new program module is encoded in machine code; and
the new program module has been tested using a test agent prior to being received at the device.

2. A method as defined in claim 1, wherein the new program module is sent to the embedded agent to implement a new test on the device.

3. A method as defined in claim 1, wherein the one or more agent modules comprise an input/output module and a control module.

4. A method as defined in claim 1, wherein the one or more agent modules comprise agent code and a microkernel.

5. An method as defined in claim 4, wherein the microkernel preformats the test data in HTTP protocol.

6. An method as defined in claim 4, wherein the microkernel preformats the test data in SMTP protocol.

7. A method as defined in claim 1, wherein the new program module is obtained by a method comprising:
obtaining test program code that is encoded in source code and compiling the test program code into a new program module;
testing the compiled new program module using a test agent having one or more modules that are similar to modules of the embedded agent; and
upon determining that the test agent operates as desired when testing the compiled new program module, transmitting the compiled new program module to the embedded agent.

8. A method as defined in claim 7, wherein transmitting the compiled program module comprises replacing an existing program module at the device.

9. A method as defined in claim 7, wherein transmitting the compiled program module comprises adding the compiled program module to one or more existing program modules at the device.

10. A method for dynamically monitoring the status of a connectivity device having embedded agent software, the method comprising:
operating the embedded agent with one or more existing program modules, wherein the embedded agent includes one or more agent modules that communicate with the existing program modules;
from a network device, transmitting system test data to the embedded agent;
receiving returned test data from the embedded agent; and
determining based on the returned test data whether to alter one or more existing program modules in the embedded agent by:
transmitting to the embedded agent a new program module; and
storing the new program module such that the new program module is made available to the embedded agent.

11. A method as defined in claim 10, wherein the system test data is transmitted to the embedded agent remotely.

12. A method as defined in claim 10, wherein the new program module is encoded in machine code.

13. A method as defined in claim 10, wherein the new program module is downloaded dynamically by the agent, in response to a specific situation.

14. A method as defined in claim 10, further comprising testing the new program module using a test agent prior to transmitting the new program module to the embedded agent at the device.

15. A method as defined in claim 10, wherein the one or more agent modules comprise an input/output module and a control module.

16. A method as defined in claim 10, wherein the one or more agent modules comprise agent code and a microkernel.

17. A dynamic embedded agent comprising:
an input/output module;
a control module;
at least one program module that includes code for implementing an operation of the embedded agent, the at least one program module having been compiled and tested in a test agent prior to being made available to the embedded agent; and
an application program that enables the input/output module and the control module to communicate with the at least one program module.

18. An agent as defined in claim 17, wherein the input/output module and the control module comprise the same module.

19. A dynamic embedded agent comprising:
at least one program module that includes code for implementing an operation of the embedded agent to obtain test data, the at least one program module having been compiled and tested in a test agent prior to being made available to the embedded agent;
agent code configured to interface with the program module to enable the program module to create test data in response to the operation of the embedded agent and to initiate the transmission of the test data in data packets; and
a microkernel configured to preformat the data packets prior to transmitting the data packets to an operating system associated with the agent.

20. An agent as defined in claim 19, wherein the microkernel preformats the data packets by adding a known source and destination address of the network device such that the operating system can send data packets originating from multiple different program modules using only a single network connection, without processing individual packets.

21. An agent as defined in claim 19, wherein the microkernel preformats the data packets in HTTP protocol.

22. An agent as defined in claim 19, wherein the microkernel preformats the data packets in SMTP protocol.
